(19) United States
(12) Patent Application Publication
(10) Pub. No.: US 2021/0381835 A1
(43) Pub. Date: Dec. 9, 2021

(54) INERTIAL MEASURING UNIT WITH REDUCED SENSITIVITY TO THERMOMECHANICAL CONSTRAINTS

(71) Applicant: SAFRAN ELECTRONICS & DEFENSE, PARIS (FR)

(72) Inventors: Jérôme CUINAT, PARIS (FR); Paul VANDEBEUQUE, PARIS (FR)

(21) Appl. No.: 17/288,402

(22) PCT Filed: Oct. 24, 2019
(86) PCT No.: PCT/EP2019/079101

§ 371 Date: Apr. 23, 2021

(30) Foreign Application Priority Data
Oct. 24, 2018 (FR) 18 59841

(51) Int. Cl. G01C 19/5783; G01C 21/16

(52) U.S. Cl. CPC G01C 19/5783; G01C 21/16

(57) ABSTRACT

A measurement unit comprising at least two elements, namely a block and an inertial sensor, a first of the elements being provided with studs, each having a surface against which a bearing surface of a second of the elements is applied under a force substantially normal to said surfaces, which force is exerted by at least one clamping element, the studs being of dimensions and shape adapted:
to allow the studs to deform under the effect of a thermomechanical stress occurring in an operating temperature range of the measurement unit so as to avoid any slip of said surfaces relative to one another under the effect of that stress; and
to keep the inertial sensor in position while ensuring that any transmission of vibration is limited and compatible with the operation of the sensor.

The present invention relates to the field of measurement, and more particularly to the field of inertial measurement.

### TECHNOLOGICAL BACKGROUND

An inertial measurement unit generally comprises a block, commonly referred to as an inertial sensor block or ISB, on which inertial sensors are mounted. The inertial sensors usually comprise three linear sensors, or “accelerometers”, and three angular sensors such as free gyros or rate gyros. The inertial sensors are arranged relative to three axes of a measurement reference frame in such a manner that:
the linear sensors detect the components along each of these three axes of the movements to which the block is subjected; and
the angular sensors detect the rotations of the block about each of these three axes.

Usually, each inertial sensor comprises a plate or substrate that carries a sensing element. The plate is provided with a baseplate for forming a plane bearing surface for bearing against a corresponding surface of the block, and with holes extending perpendicularly to the baseplate in order to receive, with clearance, screws are engaged in the block. The force with which the screws are tightened generates tension in each of them such that each screw exerts on the plate a force that is normal to the baseplate and that presses the baseplate against the corresponding surface of the block. Thus, immobilization of the plate relative to the block parallel to the baseplate depends on:
the tension in each screw; and
the coefficient of friction between the baseplate and the block.

It is not uncommon for the plate and the block to be made of different materials. These materials might have coefficients of thermal expansion that are different. When the inertial measurement unit is subjected to temperature variations, these variations give rise to differential expansions of the different materials, and thus to thermomechanical stresses, which are taken up by the fastening of the plate of the block, and which have an influence of the performance of the inertial sensors.

It is known to model the influence of temperature variations on the performance of the inertial measurement unit and to deduce correction or compensation parameters from the model in order to enable the performance of the inertial measurement unit to be maintained at a level that is acceptable within the operating temperature range expected during future use of the inertial measurement unit.

However, if thermomechanical stresses are large, they run the risk of causing the plate to slip relative to the block: this results in a change in the mechanical stresses that is difficult to predict and that does not take place in a manner that is constant and repeatable.

### OBJECT OF THE INVENTION

An object of the invention is to provide means for limiting the influence of temperature on the performance of a measurement unit.

### BRIEF SUMMARY OF THE INVENTION

To this end, the invention provides a measurement unit according to claim 1.

Thus, the thermomechanical stresses give rise to deformation of the studs without slip between the bearing surfaces. Fortunately, such deformation is repeatable (i.e. for a given thermomechanical stress, there will always be the same deformation) and simpler to model.

Other characteristics and advantages of the invention appear on reading the following description of particular, nonlimiting embodiments of the invention.

### BRIEF DESCRIPTION OF THE DRAWINGS

Reference is made to the accompanying drawings, in which:

FIG. 1 is a diagrammatic perspective view of an inertial measurement unit of the invention;

FIG. 2 is a diagrammatic view showing the principle for positioning sensors in this inertial measurement unit;

FIG. 3 is a perspective view of a first embodiment of the block of this inertial measurement unit;

FIG. 4 is a fragmentary diagrammatic view of said unit, in section on a plane IV of FIG. 3;

FIG. 5 is a fragmentary diagrammatic view of said unit, in section on a plane V of FIG. 3; and

FIG. 6 is a perspective view of a second embodiment of the block of this inertial measurement unit.

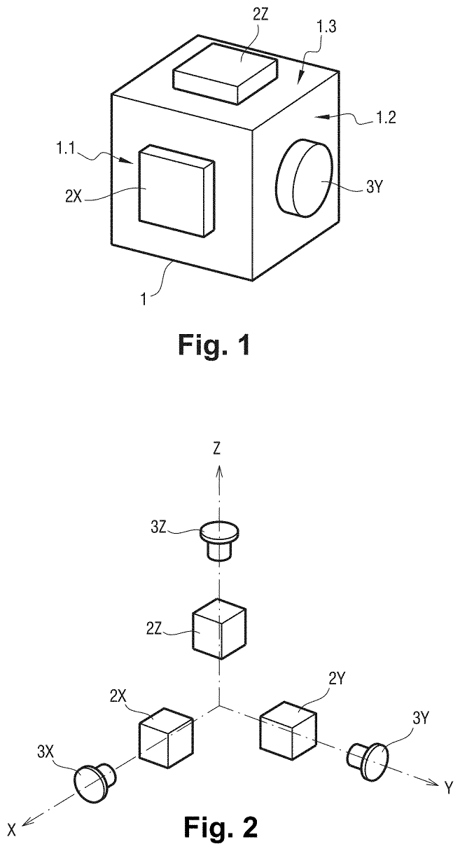

### DETAILED DESCRIPTION OF THE INVENTION

With reference to the figures, the inertial measurement unit of invention comprises a plurality of elements, namely a block 1 and inertial sensors. The inertial sensors comprise three linear sensors, generally referenced 2x, 2y, 2z, which are accelerometers, and three angular sensors, generally referenced 3x, 3y, 3z, which in this example are rate gyros. The inertial sensors 2x, 2y, 2z, 3x, 3y, and 3z are arranged relative to three axes x, y, z of a measurement reference frame R in such a manner that:
the linear sensors 2x, 2y, and 2z detect the components along each of these three axes of the movements to which the block 1 is subjected; and
the angular sensors 3x, 3y, and 3z detect the rotations of the block about each of these three axes.

Each linear sensor 2x, 2y, and 2z comprises a plate (or substrate) carrying a sensing component 22 for sensing acceleration. In this example, the plate 21 is made of metal, and more particularly of steel or of an alloy of iron and nickel. The plate 21 has a bearing surface or baseplate 23 that is provided with holes 24 of axes perpendicular to the baseplate 23. Each hole is a through hole for receiving a screw 40 for fastening the plate 21 to the block 1.

Each angular sensor 3x, 3y, and 3z comprises a plate (or substrate) carrying a sensing component 32 for sensing angular rotation. In this example, the sensing component 32 comprises a vibrating resonator. In this example, the plate 31 is made of ceramic. The plate 31 has a bearing surface or baseplate 33 that is provided with holes 34 of axes perpendicular to the baseplate 33. Each hole is a through hole for receiving a screw 40 for fastening the plate 31 to the block 1.

In this example, the block 1 is substantially in the shape of a cube having six faces (with only the faces 1.1, 1.2, and 1.3 being visible in this example), each of which has a respective one of the inertial sensors 2x, 2y, 2z, 3x, 3y, and 3z fastened thereto. In this example, the block 1 is a single part made of metal, and more particularly of steel.

Studs 10 project from each of the faces of the block 1, each stud having a terminal surface 11 against which the baseplate 23 or 33 of the plate 21 or 31 of one of the inertial sensors 2x, 2y, 2z, 3x, 3y, and 3z is applied. Each stud 10 is provided with a tapped hole 12 of axis perpendicular to its terminal surface 11 in order to receive the threaded end portion of one of the screws 40.

It can be understood that each screw 40 constitutes a clamping element that is put under tension by the torque to which it is tightened so as to exert on the plate 21 or 31 a force normal to the baseplate 23 or 33, thereby pressing the baseplate 23 or 33 against the terminal surface 11 of the stud 10 in which the screw is engaged.

The dimensions and the shape of the studs 10 are adapted so as:
to allow the studs 10 to deform under the effect of a thermomechanical stress occurring in an operating temperature range of the measurement unit so as to avoid any slip of the baseplate 23 or 33 relative to the terminal surface 11 under the effect of that stress;
to keep the inertial sensor in position while ensuring that any transmission of vibration is limited and compatible with the operation of the inertial sensor 2x, 2y, 2z, 3x, 3y, or 3z.

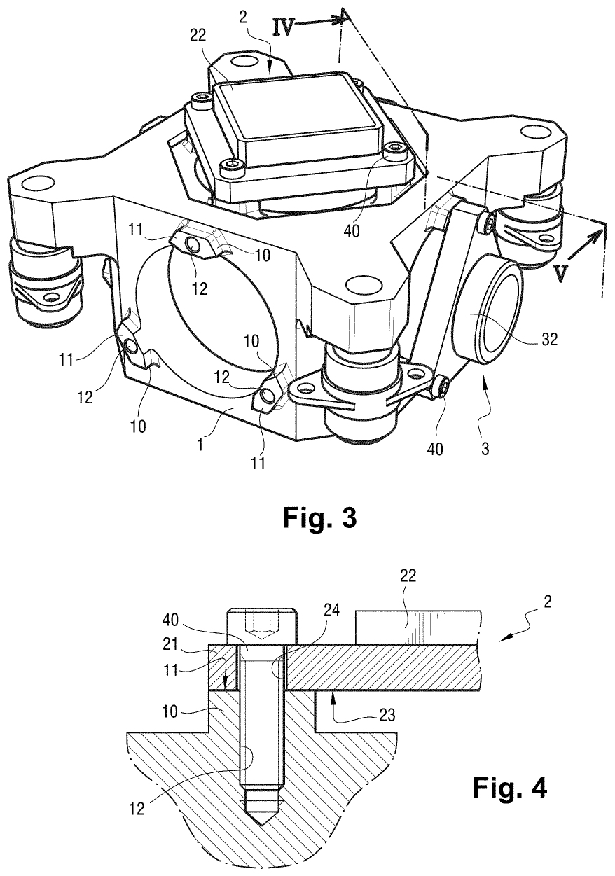

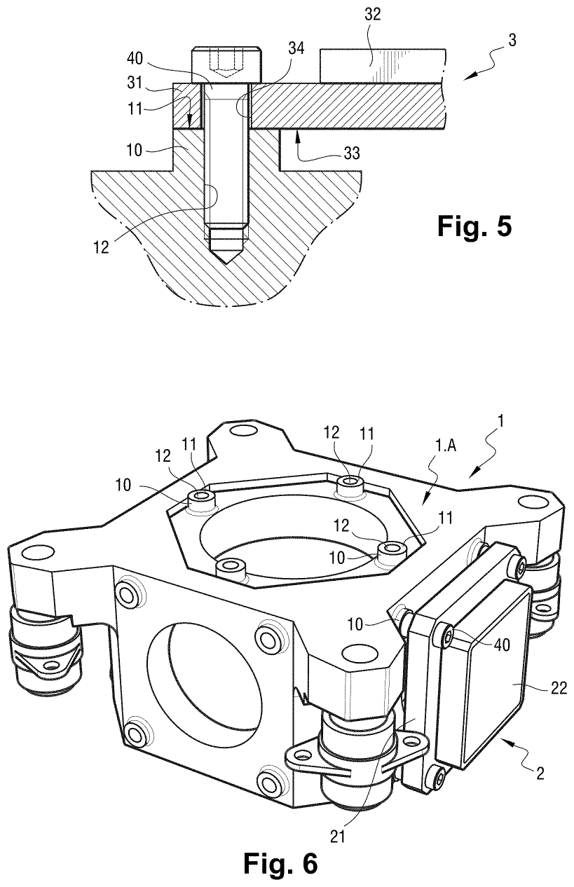

With reference more particularly to FIG. 3, the studs 10 on each face of the block 1 present a cross-section that is oblong and curved in shape. In this example, the curvature of the studs 10 is centered substantially on the geometrical center of the face in question, and the studs 10 are arranged symmetrically about that center.

By way of example, the dimensions of each stud are as follows:
3 mm for its height;
6 mm for its width; and
10 mm for its length.

With reference more particularly to FIG. 6, the studs 10 have a cross-section that is circular in shape. The studs 10 on each face of the block 1 are arranged symmetrically relative to the center of the face in question.

By way of example, the dimensions of each stud are as follows:
3 mm for its height; and
6 mm for its diameter.

Naturally, the invention is not limited to the embodiments described, and on the contrary covers any variant coming within the ambit of the invention as defined by the claims.

The number and the type of inertial sensors mounted on the block may be different from the description.

The inertial sensors may optionally comprise at least one linear sensor and at least one angular sensor.

The angular sensors may be of any structure suitable for the intended application. The angular sensors may comprise vibrating resonators (of bell or beam shape) or they may operate on some other principle (e.g. a laser gyro).

The angular sensors may be free gyros or rate gyros.

The inertial sensors may be made in conventional (or macro mechanical) manner, or they may be in the form of micro-electromechanical systems (MEMS).

The block 1 may be a single part or a plurality of parts fastened together by any means, and in particular by bolting, welding, . . . . The block 1 may be made of a material other than that described, and for example it may be made of aluminum.

The studs may be parts of the plates and not of the block 1.

The studs may be cylinders of section that is circular, oval, or polygonal. The studs may optionally have a cross-section that is constant along their entire height. By way of example, if the section is not constant, each stud may have a base of section that is greater than the section of its free end.

Although the invention is particularly useful and effective for inertial measurement units, other applications can be envisaged using measurement units in which the sensors are not inertial sensors.

1. A measurement unit comprising at least two elements, namely a block and a sensor, a first of the elements being provided with studs, each having a surface against which a bearing surface of a second of the elements is applied under a force substantially normal to said surfaces, which force is exerted by at least one clamping element, the studs being of dimensions and shape adapted:
to allow the studs to deform under the effect of a thermomechanical stress occurring in an operating temperature range of the measurement unit so as to avoid any slip of said surfaces relative to one another under the effect of that stress; and
to keep the sensor in position while ensuring that any transmission of vibration is limited and compatible with the operation of the sensor.

2. The measurement unit according to claim 1, wherein the sensor is an inertial sensor.

3. The measurement unit according to claim 1, comprising a plurality of inertial sensors mounted on the block.

4. The measurement unit according to claim 3, wherein the inertial sensors comprise at least one linear sensor and at least one angular sensor.

5. The measurement unit according to claim 4, wherein the angular sensor comprises a vibrating resonator.

6. The measurement unit according to claim 4, wherein the linear sensor and the angular sensor are made up of different materials and the block is a part made of a single material.

7. The measurement unit according to claim 1, wherein the studs are parts of the block.

8. The measurement unit according to claim 1, wherein the studs have a cross-section that is oblong and curved in shape.

9. The measurement unit according to claim 1, wherein the studs have a cross-section that is circular in shape.
